(19) United States
(12) Patent Application Publication
(10) Pub. No.: US 2014/0102140 A1
(43) Pub. Date: Apr. 17, 2014

(54) MULTI-GEMSTONE MOUNTING THAT CREATES ILLUSION OF A SINGLE LARGE GEMSTONE

(71) Applicant: Eric Nhaissi, New York, NY (US)

(72) Inventor: Eric Nhaissi, New York, NY (US)

(21) Appl. No.: 13/654,254

(22) Filed: Oct. 17, 2012

(51) Int. Cl. A44C 17/02; B23P 5/00

(52) U.S. Cl. 63/28; 29/10

(57) ABSTRACT

An item of jewelry comprising a gemstone setting for magnifying and enhancing the appearance of a multiplicity of gemstones set therein, creating the illusion of a single very large gem. The gemstone mounting comprises inner and outer rings, the inner setting having a portion that fits inside the outer setting. The inner ring holds a central large gemstone surrounded by a plurality of smaller gemstones. A reflective surface on the outer ring is highly polished and/or coated with a reflective coating. To an observer, the array of gemstones supported by the inner ring has the appearance of a single very large gemstone, as light reflected onto the reflective surface by the array of gemstones held by the inner setting is further reflected back to the observer by the reflective surface of the outer ring. The gemstone setting may be incorporated into earrings, rings, bracelets, anklets, necklaces, and the like.

### BACKGROUND

The subject matter of this disclosure generally relates to jewelry and more particularly to gemstone mountings and related structures.

Light reflected and refracted by gemstones and their deep, rich colors have appealed to many people over the course of several hundred years. Also, the fungible and lasting nature of gemstones has provided investment opportunities or means to tangible secure liquid assets. Gemstone prices are related to the size and clarity of the gemstone. Much of the satisfaction that comes with the ownership of wearing of precious gemstones comes from the gemstone's appearance.

Gemstones such as diamonds, rubies, and emeralds are often cut into standard shapes and sizes that enhance the gemstone's appearance. However, despite the precious nature of gemstones, significant variance may be present between any two randomly selected, cut gemstones of the same weight. The size and cut of gemstones affect their characteristics. Larger and clearer gemstones command higher prices than smaller and flawed ones.

In order to attach gemstones to the human body, settings are needed. Such settings are used in earrings, rings for fingers, bracelets, anklets, necklaces, and the like. Most of these settings use thin prongs to hold the gemstone in place without detracting from the gem's appearance. While adequately displaying the gemstone, such settings do not necessarily complement or enhance the appearance of the gemstone.

There is a need for improvements in gemstone settings that will enhance the appearance of gemstones.

### SUMMARY

The subject matter of this disclosure is a gemstone setting for magnifying and enhancing the appearance of a multiplicity of gemstones set therein, creating the illusion of a single, very large gem. The gemstone setting comprises inner and outer rings, the inner ring having a portion that fits inside the outer ring. The inner ring holds a central large gemstone surrounded by a plurality of smaller gemstones arranged to magnify the appearance of the central large gemstone. The inner ring is located within the outer ring such that the girdle of the central large gemstone is recessed below the topmost edge of the outer ring. An inner sidewall (or “reflective surface”) at the top of the outer ring is highly polished and/or coated with a reflective coating. The reflectivity of this inner sidewall further magnifies the appearance of the gems in the inner ring, giving the appearance of a single very large gemstone, as light is reflected to the observer by the reflective surface of the outer ring. The gemstone setting may be incorporated into earrings, rings, bracelets, anklets, necklaces, and the like.

In accordance with one embodiment, a circular array of small gemstones surrounding a central large gemstone is held in an inner ring. The inner ring is held within an outer ring having a conical inner reflective sidewall that surrounds the array of gemstones and reflects light back toward a light source after light from that source has impinged upon and been reflected onto the inner sidewall by the gemstones. The gemstone array is recessed relative to the upper edge of the reflective surface so that any reflected light impinging on the reflective surface from the gemstone array will be reflected by the reflective surface toward the observer's eye, creating an illusion that the array of gemstones is a single, very large gem.

More particularly, the gemstone setting comprises an outer ring having a top edge and a reflective surface diverging upwardly from the vertical at an angle of 5 to 47 degrees, and settings for holding a plurality of gemstones (having a girdle, a table and upper facets) securely and stationary within the setting such that the upper edge of the girdle of a central gemstone is recessed below the top edge of the outer ring. Thus, the central gemstone appears larger than its actual size due to reflection of light by the reflective surface through the surrounding smaller gemstones and through the central gemstone.

It can be seen that enhancement by the setting of a gemstone's appearance provides several advantages: a lower cost is required for a gemstone that can be made to appear larger; more satisfaction is derived from owning/wearing a gemstone that appears larger; and clearer, smaller gemstones may be purchased yet achieve a visual appearance associated with a larger gemstone.

Other aspects are disclosed and claimed below.

### BRIEF DESCRIPTION OF THE DRAWINGS

FIG. 1 is an illustration, in side view, of a gemstone and various geometric features of the gemstone for use with the gemstone settings described herein.

FIG. 2A is an illustration, in top plan view, of a first embodiment of a setting for gemstones as described herein, showing a plurality of gemstones set therein.

FIG. 2B is a cross-sectional view, taken along lines 2B-2B, of the view of the gemstone shown in FIG. 2A.

FIG. 2C is a cross-sectional view of a second embodiment of a setting.

FIG. 3 is an illustration, in top plan view, of a first embodiment of a setting for gemstones as described herein, including additional circumferential settings, showing a main gemstone set therein.

FIG. 4 is an illustration, in side sectional view, of an outer ring of a first embodiment of a setting, including additional circumferential settings, as described herein.

FIG. 5 is an illustration, in side sectional view, of an inner ring of a first embodiment of a setting for gemstones as described herein, including additional circumferential settings, and showing a main gemstone set therein.

FIG. 6 is an illustration, in side sectional view, of a first embodiment of a setting, including additional circumferential settings, as described herein, showing a main gemstone set therein.

FIG. 7 is an illustration, in perspective view, of a setting for gemstones attached to a backing with a design element.

FIG. 8 is an illustration, in side view, of a backing with a design element.

FIG. 9 is an illustration, in perspective view, of a setting for gemstones attached to a simple backing.

FIG. 10 is an illustration, in side view, of a simple backing.

Reference will hereinafter be made to the drawings in which similar elements in different drawings bear the same reference numerals.

### DETAILED DESCRIPTION

Embodiments for settings are described herein for magnifying the apparent size of a gemstone. The settings generally utilize a number of features which will be described in more detail below, to create the appearance of a large gemstone out of a number of smaller gemstones, including one large central gemstone and a plurality of smaller peripheral gemstones.

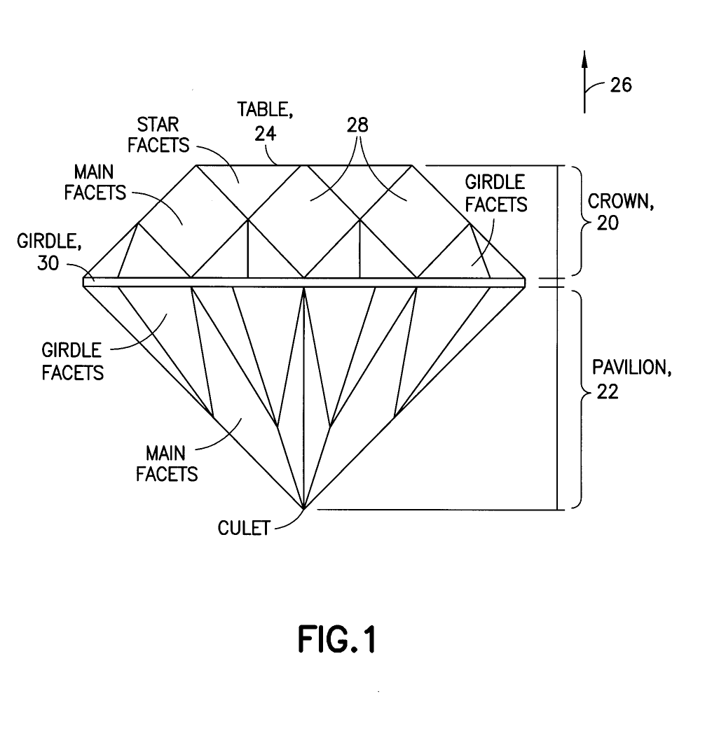

By way of introduction, a typical gemstone is shown in FIG. 1 and described. Gems are commercially available in a variety of different shapes such as round, square or princess, pear, oval, marquis and the like. The gem has a crown 20, a girdle 30 and a pavilion 22. The crown defines a table 24 facing in an upward direction 26, and a number of facets 28 facing diagonally upward with respect to the table 24.

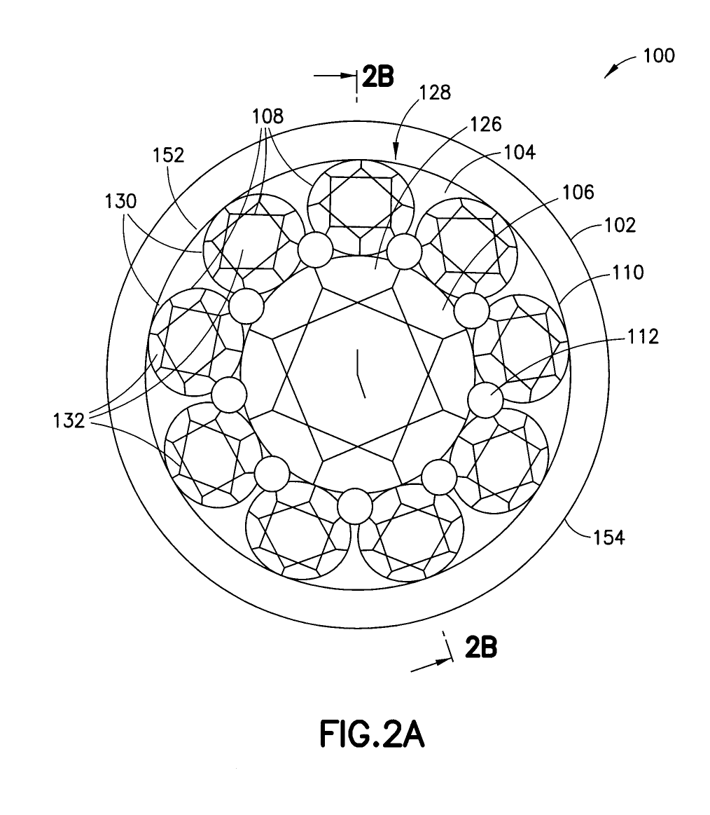

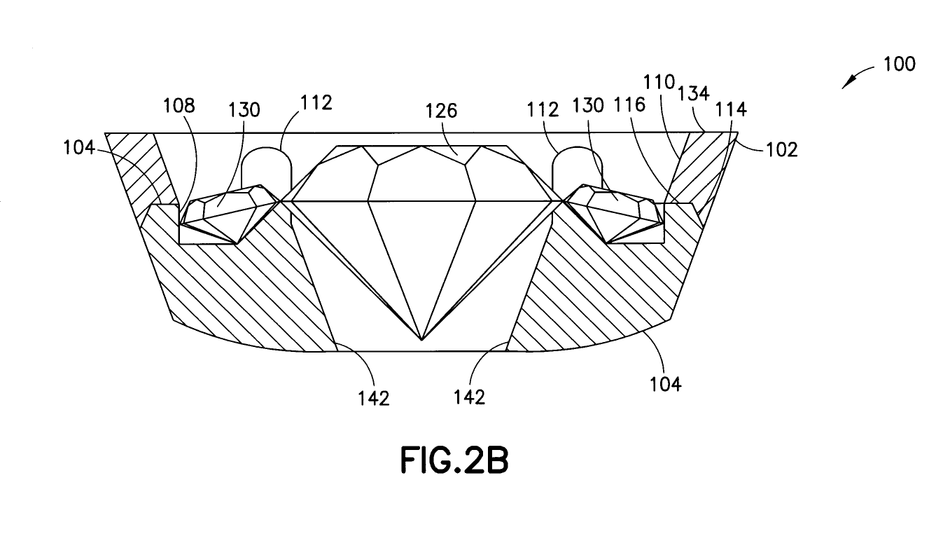

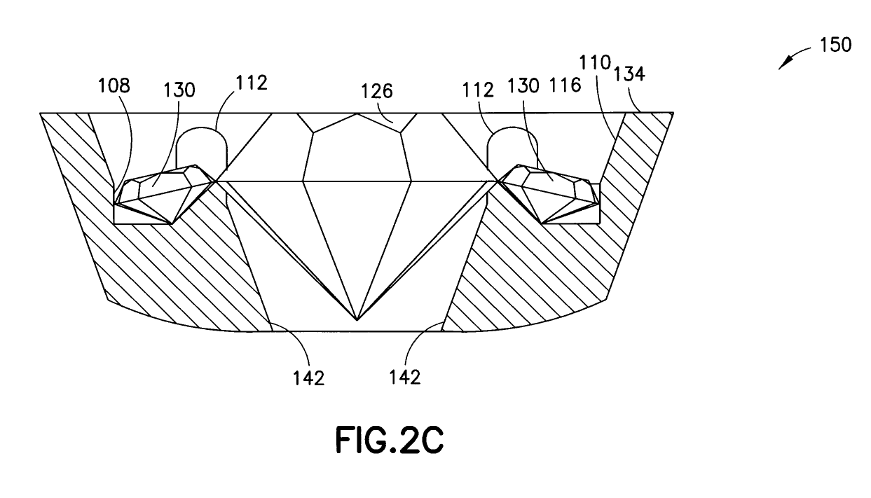

Referring to FIGS. 2A-2B, a first embodiment of a setting 100 will be described in detail. The setting 100 comprises an outer ring 102 and an inner ring 104 which are concentric. The inner ring 104 is inserted into the outer ring and has settings for a plurality of gemstones which will be described below. The settings in the inner ring 104 are arranged such that an arrangement of gemstones inserted into the settings in the inner ring 104 give the appearance of a single large gemstone by magnifying the apparent size of a single “main gemstone” (also referred to herein as a “central” gemstone). An example gem for use as a main gemstone 126 in the inner ring 104 is shown in FIG. 1.

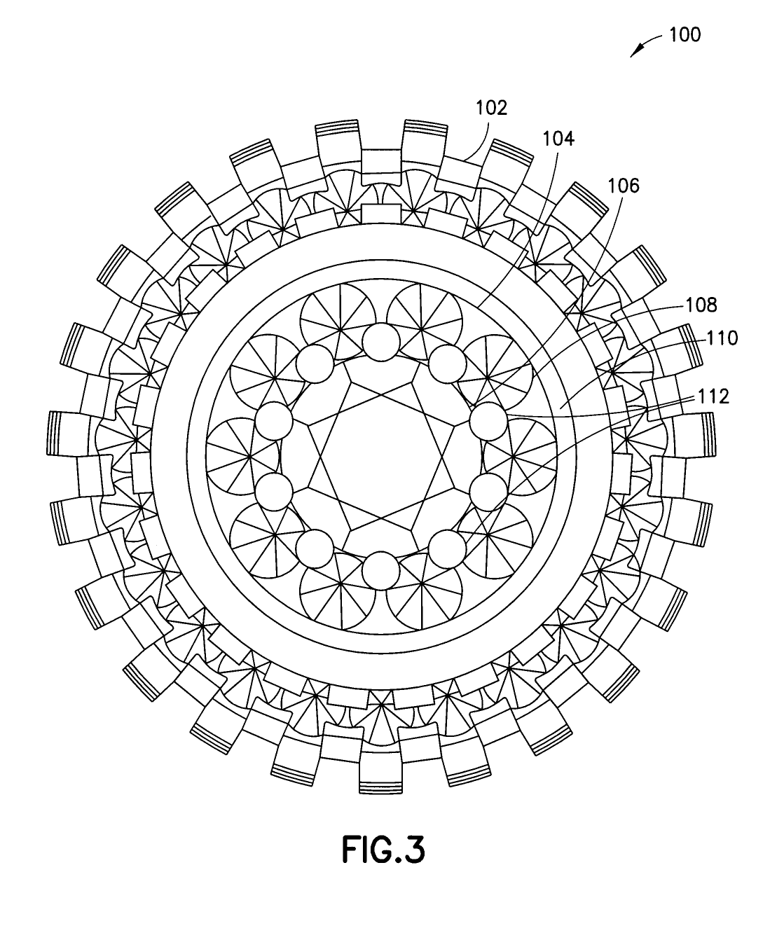

The outer ring 102 has a conical reflective surface 110 for further magnifying the size of the single central gemstone 126. The outer ring 102 may optionally have other decorative features, such as additional settings for decorative gems which do not participate in providing the appearance of a single large gemstone. This will be described later, with respect to FIGS. 3-6.

The mechanism of apparent magnification will now be described. A human observer viewing a gem typically observes light emitted from the table and facets on the crown of the gem. The appearance of a large gemstone may therefore be simulated by positioning smaller gemstones to simulate the appearance of the table and facets of a larger gemstone. For example, the appearance of a table of a large simulated gemstone may be simulated by providing a central gemstone which is smaller than the simulated gemstone. The table of the central gemstone simulates the appearance of the table of the larger simulated gemstone. The facets of the large simulated gemstone may be simulated by providing a plurality of angled peripheral gemstones positioned such that the tables of the angled peripheral gemstones in the plurality of angled peripheral gemstones appear to an observer to be the facets of the large simulated gemstone. The arrangement of one large central gemstone and a ring of concentric peripheral gemstones may therefore act to create the appearance of a large simulated gemstone from a number of smaller gemstones arranged in a particular way.

The inner ring 104 therefore contains a main setting 106 for a large central gemstone 126 and a ring 128 of circumferential settings 108 for a circumferential arrangement of peripheral smaller gemstones 130. This combination of main setting 106 and circumferential settings 108 allows positioning of gemstones in locations which provide gemstone surfaces simulating the appearance of the table and facets of a larger gemstone. This is accomplished by arranging the peripheral gemstones 130 around the main gemstone 126 such that the tables 132 of the peripheral gemstones 130 simulate the facets of a larger simulated gemstone as described above.

The inner ring 104 magnifies the apparent size of the main gemstone 126 by a factor equal to the ratio between the circumference of the circumferential arrangement of gemstones 130 to the circumference of the main gemstone 126, thereby providing the inner ring luminous area 152. This inner ring luminous area 152 is shown in FIG. 2A as being equivalent in size to the visible part of the inner ring 104.

A second element of the setting 100, the outer ring 102, further magnifies the apparent size of the main gemstone 126 by extending the inner ring luminous area 152 to an outer ring luminous area 154. As with the inner ring luminous area 152, the outer ring luminous area is shown in FIG. 2A as being equivalent in size to the visible part of the outer ring 102. This increase in size of luminous area is done by providing a conical reflector surface 110 which reflects light rays emitted from the main gemstone 126 and circumferential arrangement of gemstones 130 to an observer. The light rays reflected in this manner appear to an observer to originate within the outer ring luminous area 154 and therefore provide an appearance of a gemstone with a circumference that fills the entire outer ring luminous area 154. Thus the outer ring 102 magnifies the apparent size of the gem by a factor equivalent to the ratio between the outer ring luminous area 154 and the inner ring luminous area 152.

Regarding the measurements of the outer ring 102, and specifically the reflective surface 110, it has been found that a maximum magnification of the appearance of the gemstone due to reflection by the surface 110 occurs when two conditions are simultaneously fulfilled. The first condition is that the reflective surface 110 diverges upwardly from the vertical at an angle of 5 to 47 degrees, preferably 8 to 35 degrees, and optimally 20 to 24 degrees. Thus the included angle of the cone formed by a linearly diverging sidewall would be double the angle from the vertical, i.e., 10 to 94 degrees, preferably 16 to 70 degrees, and optimally 40 to 48 degrees. The second critical condition is that the upper edge of the girdle 30 of the main gemstone 126 is recessed below the top edge 134 of the outer ring 102, preferably with the table 24 disposed at or below the top edge 134 of the outer ring 102. The second condition may not have to be fulfilled and in fact having the table of the gemstone be at the level of the top edge 134 of the outer ring 102 may provide a better look.

Although optimal configurations are provided, many changes may be made to the vertical angle of the reflective surface 110 and the vertical location of the main gemstone 126. However, there are some limits to what alterations may be made. Where the vertical angle of the reflective surface 110 is less than the minimum of 5 degrees, there is no appreciable illusion of magnification since the reflective surface 110 is too close to the vertical and thus does not appreciably enlarge the appearance of the gem 126. Where the angle is greater than the maximum of 47 degrees, the reflection of the gemstone by the reflective surface 110 is too diffuse. If the girdle 30 of the gemstone 126 is above the top edge 134 of the outer ring 102, then there is no apparent magnification since the reflecting sidewall is not positioned to reflect the upper facets of the gemstone. If the main gemstone 126 is recessed too deeply, the viewer sees mainly the reflective surface 110 and too little of the main gemstone 126 or its reflection.

If desired, the angle formed by the reflective surface 110, relative to the vertical, may differ above and below the girdle of the gem-in other words, the reflective surface 110 may have a bend or curve therein. It has been found that setting of a gemstone (and in particular, a small gem) is simplified when the angle formed, relative to the vertical, by the portion of the reflective surface 110 below the gemstone girdle is greater than that formed by the portion of the reflective surface 110 above the gemstone girdle. More particularly, this permits the gemstone to be disposed lower within the outer ring 102, if desired, without varying the angle required to meet the first critical condition and without necessitating a change in the diameter of the base of the holder.

FIG. 2C depicts a second embodiment of a setting 150 in which the inner and outer rings of the first embodiment are fused. Additionally, the table of main gem 126 is in line with the top edge 134 of the setting 150.

Additional optional features, such as settings for additional gems, and parts for properly aligning the inner and outer rings 102, 104 will now be described with respect to FIGS. 3-6.

The inner ring 104 has a base 136 having a top side 138 and a bottom side 140. Setting features for the circumferential array of gems 130 and the main gem 126 are located on the top side 138 of the base 136 of the inner ring 104. These setting features include a main setting (e.g., a conical slot) 106 for the main gem 126, and a ring of smaller settings (e.g., conical slots) 128 for the concentric ring of smaller gems 128. The main setting 106 is vertically aligned to allow the table 24 of the main gem 106 to be parallel with the top surface 134 of the outer ring 102. The settings in the concentric ring of smaller settings 128 each point in a direction which permits the table of gems sitting within the concentric ring of smaller settings 128 to point at an angle with respect to the table of the main gem 106. This angle corresponds roughly to the angle of facets on the crown of a typical gemstone with respect to the angle of the table.

Setting beads 112 located in a circle around the main setting 106 hold in place the main gemstone 126 and the circumferential array of gems 130. To set gems in the main setting 106 and ring of smaller settings 128, gems are first placed into the settings 106, 128 and the beads 112 are pressed down to secure the gems in place. The beads 112 are sufficient to hold the main gemstone 126 in place, but the circumferential array of gems 130 may require an additional feature to secure. Such a feature can be a bezel rim 109 which can be bent over the gems in the circumferential array of gems 130 to hold the gems in place. It should be understood that these setting features are exemplary and other features which serve similar purposes may be used. For example, while a bezel setting is shown, other known means for setting the gems may be used.

In an assembled configuration, the inner ring 104 is inserted into the outer ring 102 to allow magnification of the main gemstone 126. The inner ring 104 sits within a slot 103 in the outer ring 102 which is shaped to correspond to the shape of the inner ring 104. The slot 103 opens in a downward direction to permit the inner ring 104 to be inserted into the outer ring 102 from a bottom-up direction, and to be held in the outer ring 102 by a circular lip 115 in the outer ring 102. The lip generally consists of a flat, circular surface 116 and a conical surface 114 which sit against the inner ring 104. The outer ring also has a rounded bowl-shaped surface 122 in which several notches 120 are cut. The notches receive alignment extensions 118 extending from the inner ring 104 in order to align the inner ring 104 in a proper manner. The inner ring 104 may be attached to the outer ring 102 in a wide variety of known manners. In one preferred embodiment, the inner ring 104 is soldered to the outer ring 102.

The outer ring 102 may have a number of settings 136 for additional outer gemstones. In the embodiment shown, two concentric rings (138, 140) of settings for two rings of gemstones are shown, but any number and configuration of gemstones may be present, or none at all. These rings 138, 140 are shown on a radially outward surface of the outer ring 102.

A coating, such as a rhodium coating may be applied to the reflective surface 110 of the outer ring 102. Alternatively, any reflective metal (preferably white, but even highly polished yellow gold) may be used instead of rhodium; however, rhodium has a tendency to keep its shine and reflectivity for an extended period. Preferably, the rhodium coating extends approximately two and one-half millimeters down the reflective surface 110. Alternatively, the rhodium coating may extend to the inner ring 104 or farther. The rhodium coating complements the gem's appearance and enhances the visual presentation of the main gemstone 126.

A circular aperture 142 is formed at the lower portion of the inner ring 104. This aperture 142 allows light to enter the interior of the setting 100 from the rear, and provide the main gemstone 126 with back lighting to enhance its appearance and sparkle.

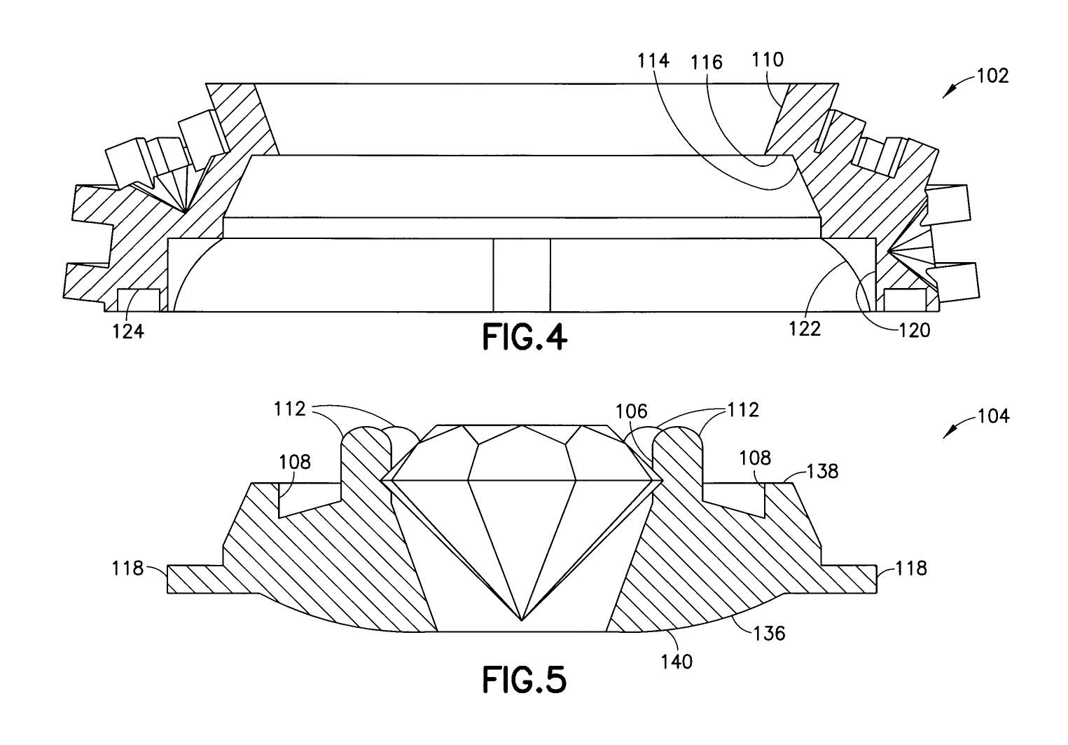

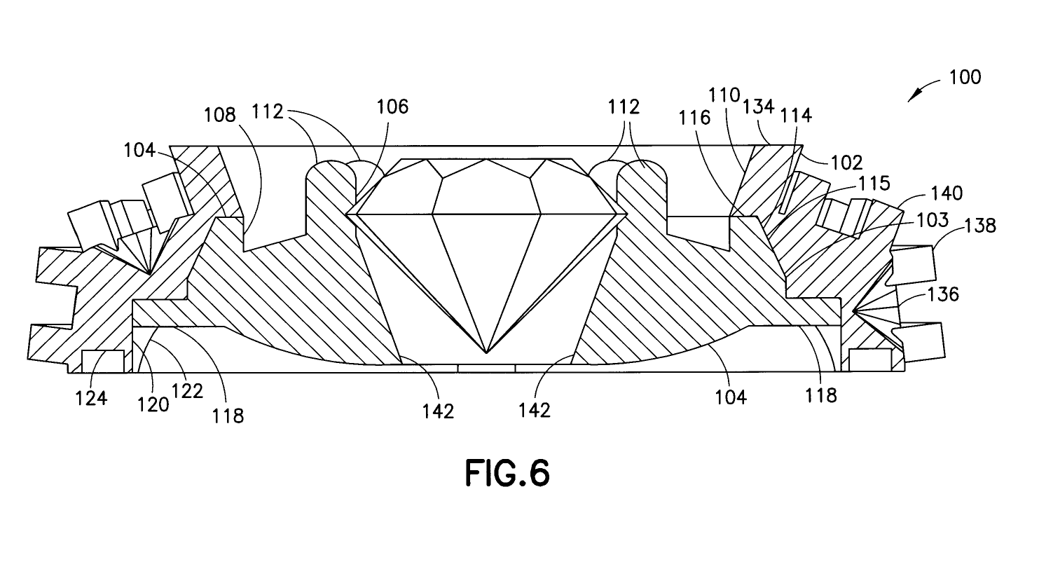

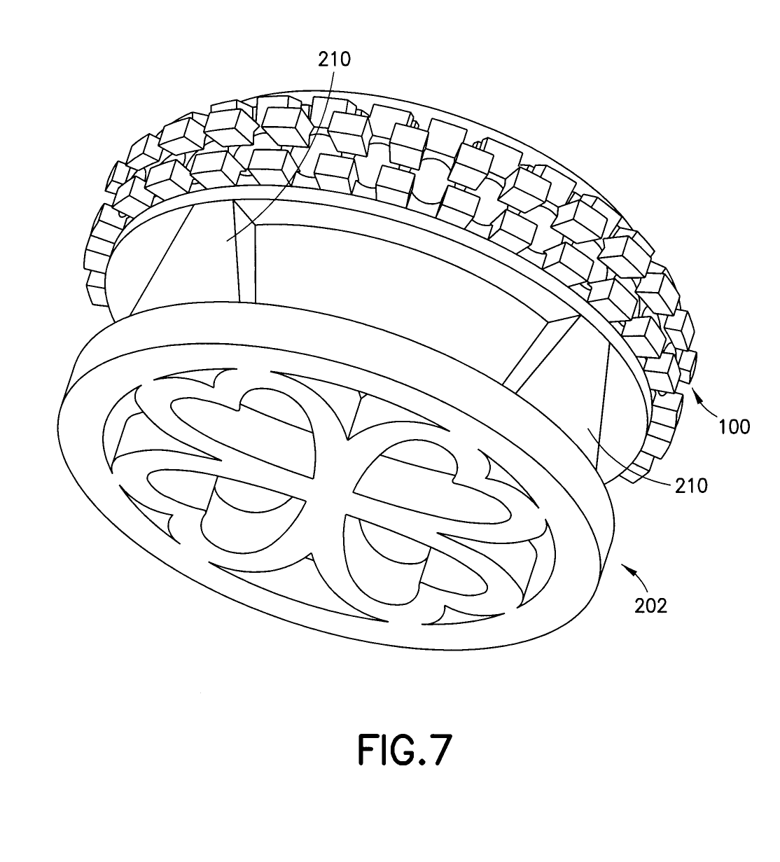

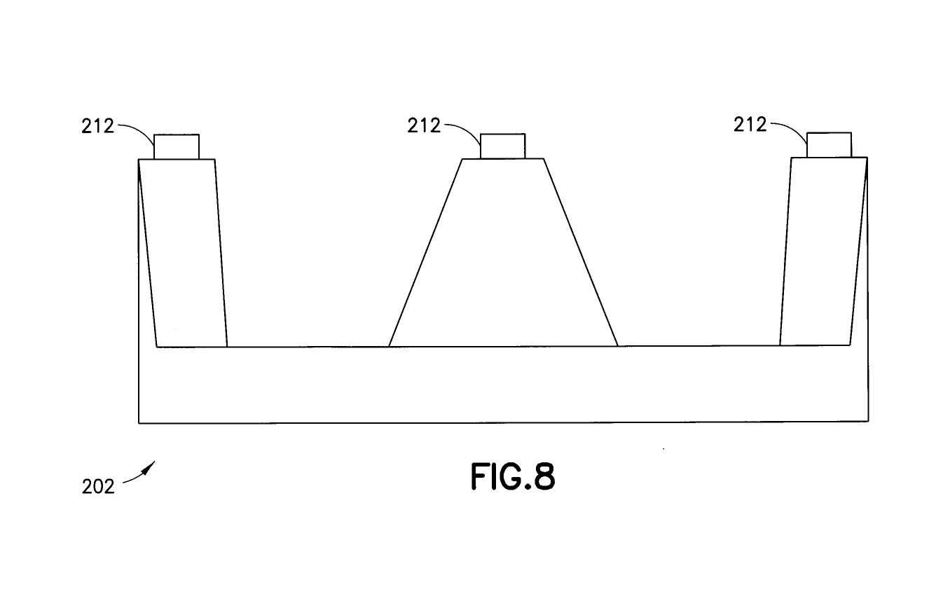

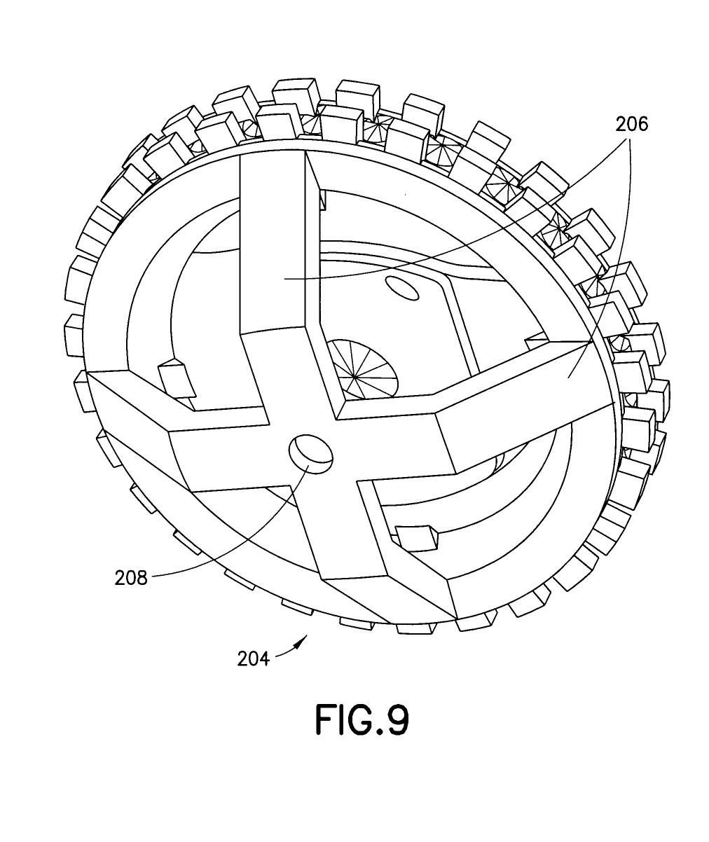

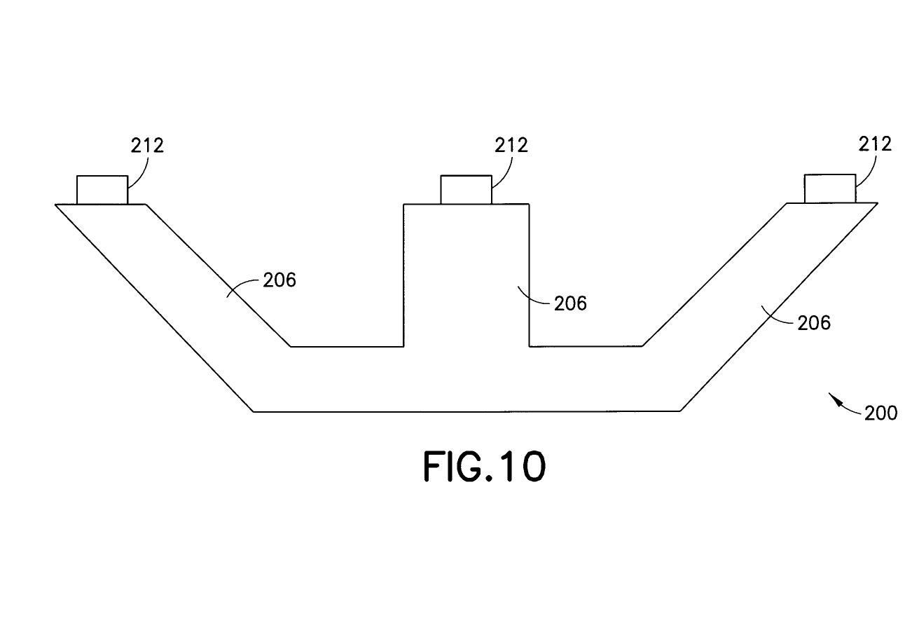

Backings for use in attaching the setting 100 to other jewelry elements such as a necklace, earring or the like are shown in FIGS. 7-10. FIGS. 7 and 8 show a backing 202 having heart shaped design elements. FIGS. 9 and 10 show a simple backing 204 having two cross bars 206. The simple backing 204 has a hole 208 which may be used to attach the setting 100 to an earring pin to allow attachment to a wearer's pierced ear. The backings 202, 204 have legs 206, 210 with nubs 212 for insertion into holes 214 (seen in FIGS. 4 and 6) in the outer ring 102 of the setting 100 for alignment and coupling. The backings 202, 204 may be soldered to the outer ring 102 or coupled in another way.

A method of assembling a setting 100 comprises setting a main gemstone 126 into a central setting 106 in an inner ring 104, setting a plurality of peripheral gemstones into a ring of peripheral settings, and inserting the inner ring 104 into the slot 103 in the outer ring 102. The rings 102, 104 may be soldered together. If additional settings are present, small gemstones may be set into the additional settings. A backing 202, 204 can then be attached to the setting 100.

While jewelry has been described with reference to various embodiments, it will be understood by those skilled in the art that various changes may be made and equivalents may be substituted for elements thereof. In addition, many modifications may be made to adapt a particular situation to the teachings without departing from the essential scope thereof. Therefore it is intended that the claims not be limited to the particular embodiments disclosed.

1. An item of jewelry comprising:
an inner ring comprising a central setting for a main gemstone and a first ring of peripheral settings surrounding the central setting, for a first plurality of peripheral gemstones, said inner ring defining a vertical axis; and
an outer ring comprising a conical light-reflective surface coupled to a slot shaped to receive said inner ring, said light-reflective surface having an angle of inclination relative to said vertical axis.

2. The jewelry item as recited in claim 1, further comprising:
a central main gemstone comprising a pavilion that extends into said central setting and a crown that is disposed above said central setting; and
a plurality of gemstones smaller than and surrounding said central gemstone, not overlying said central opening, and inserted into said ring of peripheral settings.

3. The jewelry item as recited in claim 1, further comprising alignment extensions extending from said inner ring and inserted into notches in said outer ring.

4. The jewelry item as recited in claim 1, wherein said angle of inclination between 20 and 24.

5. The jewelry item as recited in claim 1, wherein said plurality of peripheral gemstones are arranged in a circular shape.

6. The jewelry item as recited in claim 1, further comprising a second plurality of peripheral gemstones disposed outside and surrounding said reflective surface.

7. The jewelry item as recited in claim 1, further comprising:
alignment extensions extending from said inner ring and inserted into notches in said outer ring.

8. The jewelry item as recited in claim 7, further comprising a backing that is attached to said outer setting.

9. An item of jewelry comprising:
an inner ring defining a vertical axis and comprising a central setting for a main gemstone, a first ring of peripheral settings surrounding the central setting, for a plurality of peripheral gemstones, and a plurality of bead setting features surrounding and projecting upward from said central setting, said inner ring being inserted into an outer ring comprising a reflective surface that encircles said ring of peripheral settings, said reflective surface being a section of a cone having a vertical axis that is generally collinear with said vertical axis, the reflective surface having an angle of inclination with respect to said vertical axis;
a central large gemstone comprising a girdle in contact with and held in place by said multiplicity of prongs, a pavilion that extends into said central setting, and a crown disposed above said central setting; and
a first plurality of gemstones disposed in said first plurality of gemstone settings, one gemstone in each gemstone setting.

10. The jewelry item as recited in claim 9, wherein said angle of inclination is between 20 and 24 degrees.

11. The jewelry item as recited in claim 9, further comprising:
a second ring of peripheral settings disposed on said outer ring radially outward of said reflective surface; and
a second plurality of gemstones respectively disposed in said second ring of peripheral settings.

12. The jewelry item as recited in claim 11, further comprising:
alignment extensions extending from said inner ring and inserted into notches in said outer ring.

13. The jewelry item as recited in claim 9, further comprising a backing that is attached to said outer ring.

14. A method of manufacturing an item of jewelry comprising:
providing an inner ring comprising a central setting for a main gemstone and a first ring of peripheral settings surrounding the central setting, for a first plurality of peripheral gemstones, said inner ring defining a vertical axis;
providing an outer ring comprising a conical light-reflective surface coupled to a slot shaped to receive said inner ring, said light-reflective surface having an angle of inclination relative to said vertical axis;
setting a main gemstone into said central setting, and a first plurality of peripheral gemstones into said first ring of peripheral settings; and
inserting said inner ring into said slot.

15. The method as recited in claim 14, wherein said angle of inclination is in a range of 20 to 24 degrees inclusive.

16. The method as recited in claim 14, further comprising:
setting a second plurality of peripheral gemstones into a second ring of peripheral settings disposed on the outer ring outside and surrounding said light-reflective surface.

17. The method as recited in claim 16, further comprising attaching said inner ring to said outer ring.

18. The method as recited in claim 14, further comprising:
coupling a backing to said outer ring.

19. The method as recited in claim 14, wherein setting said main gemstone into said central setting further comprises ensuring that a table of said main gemstone is below a top edge of said reflective surface.

20. The method as recited in claim 14, wherein setting said main gemstone further comprises ensuring that a girdle of said main gemstone is below a top edge of said reflective surface.
